(19) United States
(12) Patent Application Publication
(10) Pub. No.: US 2011/0023776 A1
(43) Pub. Date: Feb. 3, 2011

(54) SPRAY DEVICE HAVING LIQUID BLOCKING SCREEN

(75) Inventors: Mark A. Etzler, Angola, IN (US); Steve P. Norton, Coldwater, MI (US)

Correspondence Address: FLETCHER YODER (ILLINOIS TOOL WORKS INC.), P.O. BOX 692289, HOUSTON, TX, 77269-2289, US

(73) Assignee: Illinois Tool Works Inc., Glenview, IL (US)

(21) Appl. No.: 12/843,826

(22) Filed: Jul. 26, 2010

Related U.S. Application Data
(60) Provisional application No. 61/230,462, filed on Jul. 31, 2009.

(51) Int. Cl. B05B 5/025

(52) U.S. Cl. 118/621; 118/300

(57) ABSTRACT

A system is provided for blocking ingress of liquid in a spray device. The system includes a spray device gasket having a gasket pad and a liquid blocking screen. The liquid blocking screen may be coupled to the gasket pad, wherein the liquid blocking screen is configured to enable gas flow in a first direction and block liquid flow in a second direction opposite from the first direction.

### CROSS REFERENCE TO RELATED APPLICATIONS

This application claims priority from and the benefit of U.S. Provisional Patent Application Ser. No. 61/230,462, entitled “Spray Device Having Liquid Blocking Screen”, filed Jul. 31, 2009, which is hereby incorporated by reference.

### BACKGROUND

The invention relates generally to spray coating devices, and more particularly to control of fluid flow.

Spray coating devices often include multiple fluid flows that merge together to form a spray. For example, a spray coating device may include both liquid and air passages configured to flow liquid and air toward a spray tip. Unfortunately, in some situations, the liquid may enter the air passage. The liquid may be a cleaning liquid, paint, or some other coating liquid. As a result, the liquid may clog the air passage or cause damage to components further upstream in the air passage.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a spray device gasket having a gasket pad and a liquid blocking screen coupled to the gasket pad. The liquid blocking screen is configured to enable gas flow in a first direction and block liquid flow in a second direction opposite from the first direction.

In a second embodiment, a system includes a spray device component and a liquid blocking screen coupled to the spray device component. The liquid blocking screen is configured to enable gas flow in a first direction and block liquid flow in a second direction opposite from the first direction.

In a third embodiment, a system includes a portable spray device having a liquid blocking screen. The portable spray device includes a spray head having a liquid port and an air port. The portable spray device includes a body having a barrel, a handle coupled to the barrel, a power module coupled to the handle, an air path from the power module to the spray head, and a liquid path to the spray head. The power module includes an air turbine coupled to an electrical generator. The liquid blocking screen may be disposed along the air path between the power module and the air port.

### DRAWINGS

These and other features, aspects, and advantages of the present invention will become better understood when the following detailed description is read with reference to the accompanying drawings in which like characters represent like parts throughout the drawings, wherein:

FIG. 1 is a diagram illustrating an embodiment of a spray coating system incorporating unique paint blocking screens;

FIG. 2 is a flow chart illustrating an embodiment of a spray coating process using unique paint blocking screens;

FIG. 3 is a perspective view of an embodiment of an electrostatic spray gun having unique paint blocking screens;

FIG. 4 is an exploded perspective view of the electrostatic spray gun of FIG. 3, illustrating two unique paint blocking screens;

FIG. 5 is a cross-sectional view of the electrostatic spray gun of FIG. 3 taken along line 5-5, illustrating a unique gasket having two paint blocking screens;

FIG. 6 is a perspective view of the gasket of FIG. 5;

FIG. 7 is a partial cross-sectional view of the electrostatic spray gun of FIG. 5 taken along line 7-7; and

FIG. 8 is a partial cross-sectional view of the electrostatic spray gun of FIG. 7 taken within line 8-8.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As discussed in detail below, a liquid blocking screen may be used in a spray device, such as a paint spray gun, to block ingress of liquid upstream into air passages. In particular, in certain applications, air passages include sensitive mechanical and/or electrical components, which become damaged by any ingress of liquid. For example, a spray device may include valves, motors, generators, circuits, or other sensitive components that would short out or cease working upon ingress of liquid. Although a check valve may be used to block ingress of liquid, the check valve generally creates a large pressure drop, which can affect performance of the spray device. Furthermore, the check valve consumes a considerable amount of space, increases costs, increases complexity, and can become clogged over time. Thus, in certain embodiments discussed in detail below, one or more liquid blocking screens are disposed along air passages to resist upstream flow of liquid (e.g., paint), thereby protecting the sensitive devices upstream. The liquid blocking screens may be designed with a plurality of openings sized to minimize the pressure drop of airflow in the downstream direction, while substantially or completely blocking liquid flow in the upstream direction. Furthermore, as discussed below, the liquid blocking screens may be coupled to gaskets, flow control components, or other spray device components throughout the spray device. The liquid blocking screens may be constructed with a variety of pore sizes, materials, and arrangements of pores. For example, the liquid blocking screens may be made with a metal alloy, a plastic, a ceramic, or fibrous material. In some embodiments, the liquid blocking screens may be constructed with a weave or mesh of wire, fibers, or strands of metal or fiber material, such as stainless steel, fiberglass, or another suitable material. Although the following discussion focuses on spray devices, it should be appreciated that the disclosed embodiments may be employed in any application having both gas and liquid flows that could potentially result in undesirable flow of liquid upstream into gas passages.

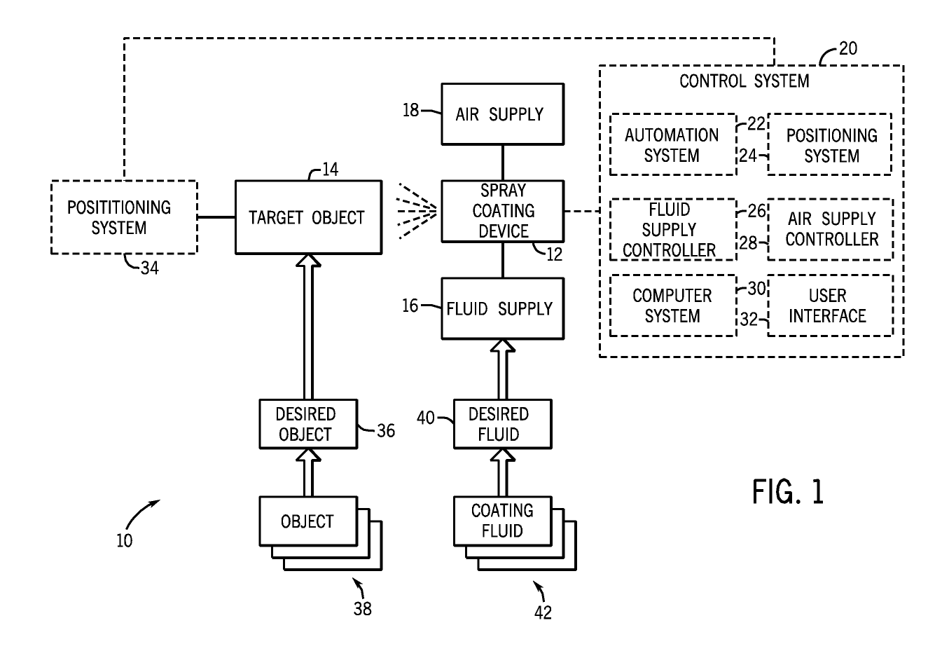

FIG. 1 is a flow chart illustrating an embodiment of a spray coating system 10, which includes a spray coating device 12 (e.g., spray gun) for applying a desired coating to a target object 14. As discussed in detail below, embodiments of the spray gun 12 may include one or more screen gaskets and/or liquid blocking screens, which are configured to enable gas flow (e.g., air flow) while substantially blocking liquid flow. For example, the screen gaskets and/or liquid blocking screens may be disposed in one or more airflow paths to block any ingress of liquid (e.g., coating liquid or cleaning solvent) from reaching liquid sensitive internal components (e.g., electronics). Thus, the screen gaskets and/or liquid blocking screens may be disposed at any suitable location in the spray gun 12.

The illustrated spray gun 12 may be coupled to a variety of supply and control systems, such as a fluid supply 16, an air supply 18, and a control system 20. The control system 20 facilitates control of the fluid and air supplies 16 and 18 and ensures that the spray gun 12 provides an acceptable quality spray coating on the target object 14. For example, the control system 20 may include an automation system 22, a positioning system 24, a fluid supply controller 26, an air supply controller 28, a computer system 30, and a user interface 32. The control system 20 also may be coupled to a positioning system 34, which facilitates movement of the target object 14 relative to the spray gun 12. According, the spray coating system 10 may provide a computer-controlled mixture of coating fluid, fluid and air flow rates, and spray pattern. Moreover, the positioning system 34 may include a robotic arm controlled by the control system 20, such that the spray gun 12 covers the entire surface of the target object 14 in a uniform and efficient manner.

Spray coating system 10 of FIG. 1 is applicable to a wide variety of applications, fluids, target objects, and types/configurations of the spray gun 12. For example, a user may select a desired fluid 40 from a plurality of different coating fluids 42, which may include different coating types, colors, textures, and characteristics for a variety of materials such as metal and wood. The user also may select a desired object 36 from a variety of different objects 38, such as different material and product types. As discussed in further detail below, the spray gun 12 also may comprise a variety of different components and spray formation mechanisms to accommodate the target object 14 and the fluid supply 16 selected by the user. For example, the spray gun 12 may comprise an air atomizer, a rotary atomizer, an electrostatic atomizer, or any other suitable spray formation mechanism.

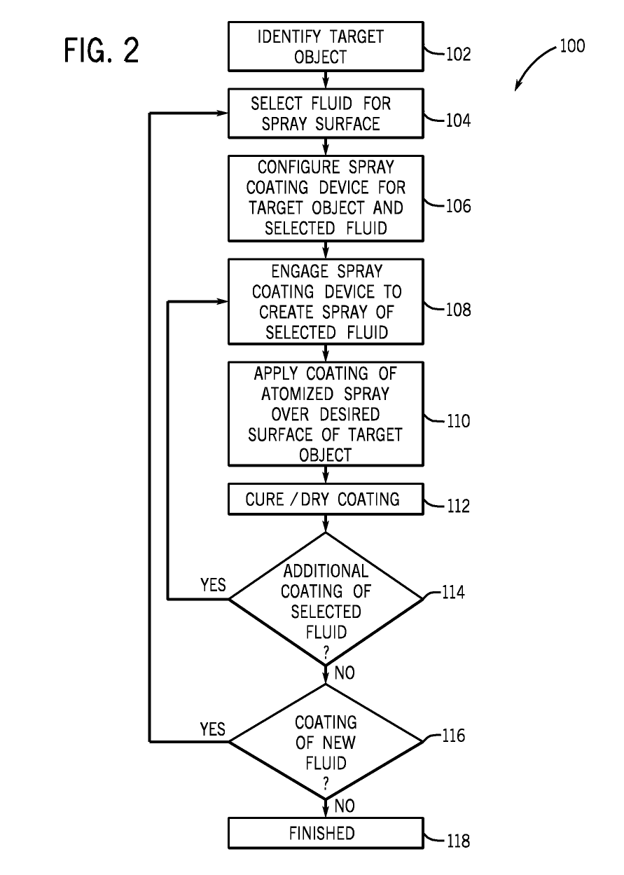

FIG. 2 is a flow chart of an embodiment of a spray coating process 100 for applying a desired spray coating to the target object 14. Again, as discussed in detail below, embodiments of the spray gun 12 may include one or more screen gaskets and/or liquid blocking screens, which are configured to enable gas flow (e.g., air flow) while substantially blocking liquid flow. As illustrated, process 100 proceeds by identifying target object 14 for application of the desired fluid (block 102). Process 100 then proceeds by selecting desired fluid 40 for application to a spray surface of the target object 14 (block 104). A user may then proceed to configure spray gun 12 for the identified target object 14 and selected fluid 40 (block 106). As the user engages spray gun 12, process 100 then proceeds to create an atomized spray of selected fluid 40 (block 108). The user may then apply a coating of the atomized spray over the desired surface of target object 14 (block 110). Process 100 then proceeds to cure/dry the coating applied over the desired surface (block 112). If an additional coating of selected fluid 40 is desired by the user at query block 114, then process 100 proceeds through blocks 108, 110, and 112 to provide another coating of the selected fluid 40. If the user does not desire an additional coating of the selected fluid at query block 114, then process 100 proceeds to query block 116 to determine whether a coating of a new fluid is desired by the user. If the user desires a coating of a new fluid at query block 116, then process 100 proceeds through blocks 104-114 using a new selected fluid for the spray coating. If the user does not desire a coating of a new fluid at query block 116, then process 100 is finished at block 118.

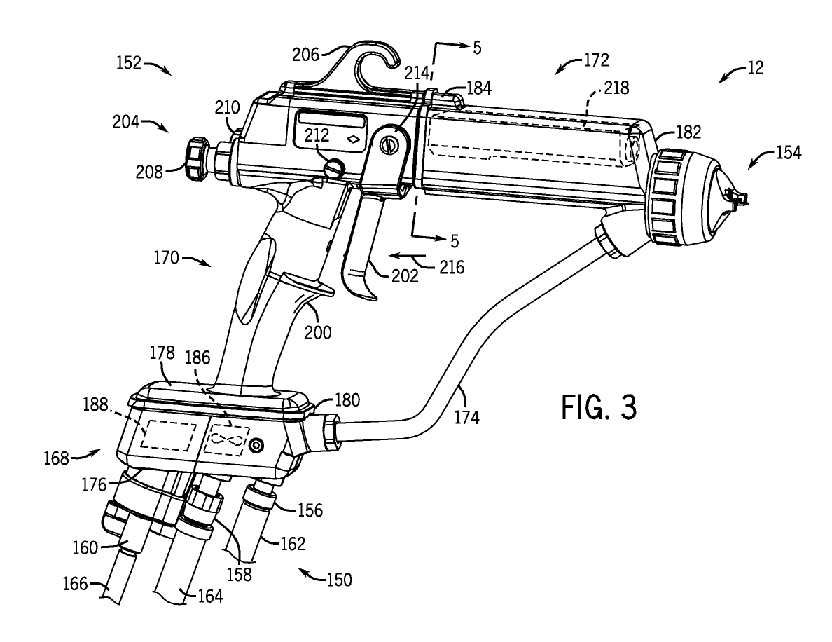

FIG. 3 is a perspective view of an embodiment of an electrostatic spray gun 12 having unique paint blocking screens. As illustrated, the spray gun 12 includes a fluid connector section 150, a body 152, and a spray head 154. As discussed in further details below, the spay gun 12 may include one or more paint blocking screens configured to enable gas flow in a first direction while blocking liquid flow in an opposite second direction. For example, the unique paint blocking screens may enable air to flow through air passages in a direction downstream to the spray head 154, while blocking paint from flowing upstream through the air passages to liquid sensitive components.

In the illustrated embodiment, the fluid connector section 150 includes a liquid inlet connector 156, and an air inlet connector 158, and an air outlet connector 160. For example, the liquid inlet connector 156 may couple to a liquid inlet conduit 162 configured to receive a coating liquid, such as paint, clear coat, wood stain, and so forth. Likewise, the air inlet connector 158 may couple to an air inlet conduit 164 configured to receive compressed air from a compressor or compressed air storage tank. As discussed further below, the air outlet connector 160 may couple to an air outlet conduit 166 configured to vent air from the spray gun 12 during operation. In certain embodiment, each of these connectors 156, 158, and 160 may be quick connectors configured to enable a quick connect and disconnect with the respective conduits 162, 164, and 166. The spray gun 12 routes the liquid and air from the conduits 162 and 164 to the spray head 154 to create a spray in the presence of an electrostatic field.

The body 152 of electrostatic spray gun 12 includes a power module 168, a handle 170, a barrel 172, and a liquid conduit 174. As illustrated, the connectors 156, 158, and 160 couple to a bottom side 176 of the power module 168. The handle 170 couples to a top side 178 of the power module 168. The liquid conduit 174 couples to a front side 180 of the power module 168 and a front side 182 of the barrel 172. The handle 170 couples to a rear side 184 of the barrel 172, while the spray head 154 couples to the front side 182 of the barrel 172. As discussed further below, the electrostatic spray gun 12 routes a portion of the air from the air inlet conduit 164 through the power module 168, through the handle 170, through the barrel 172, and out through the spray head 154. In addition, the electrostatic spray gun 12 routes liquid from the liquid inlet conduit 162 through the power module 168, through the liquid conduit 174, and out through the spray head 154.

The power module 168 includes a power generation system configured to generate electricity for creating the electrostatic field of the electrostatic spray gun 12. In the illustrated embodiment, the power module 168 includes an air turbine 186 coupled to a generator 188. The air inlet connector 158 routes compressed air from the air inlet conduit 164 through the power module 168 along an air path that drives turbine blades of the air turbine 186. As the air turbine 186 rotate within the power module 168, the rotation drives the generator 188 to create electricity. As appreciated, this electricity is used by the electrostatic spray gun 12 to create an electrostatic filed in a region surrounding the spray head 154. In the illustrated embodiment, the power module 168 routes a portion of the compressed air from the air inlet connector 158 through the handle 170, the barrel 172, and the spray head 154, while another portion of the compressed air is exhausted through the outlet connector 160. For example, the exhausted air may be a portion of the compressed air used for driving the air turbine 186. The power module 168 also routes liquid, such as paint, from the liquid inlet connector 156 through the liquid conduit 174 to the spray head 154.

The handle 170 of the electrostatic spray gun 12 includes a hand grip 200, a trigger 202, valve adjustors 204, and a hook 206. In the illustrated embodiment, the valve adjustors 204 include a liquid valve adjuster 208, a shaping air valve adjustor 210, and an atomizing air valve adjustor 212. The valve adjustors 208, 210, and 212 are coupled to internal valve assemblies, which control the fluid flow of liquid and air through the electrostatic spray gun 12 to the spray head 154. In addition, the trigger 202 is configured to open and close the internal valve assemblies associated with the valve adjustors 204. For example, the illustrated trigger 202 rotates about a joint 214 to move the internal valve assemblies forward and rearward within the body 152. As a user pulls the trigger 202 in a rearward direction 216, the internal valve assemblies open the flow of air and liquid through the spray head 154 to create a spray. At this time, the electrostatic spray gun 12 also creates an electrostatic field to charge liquid droplets in the spray.

In the illustrated embodiment, the barrel 172 of the electrostatic spray gun 12 may include a cascade 218 configured to generate a high voltage DC charge for the creation of an electrostatic field between the spray head 154 and the target object. For example, the cascade 218 may receive electricity from the generator 188 within the power module 168, and transfer the high voltage DC charge to an electrode in the spray head 154. In certain embodiment, the cascade 218 may be configured to provide a tip voltage of approximately 50 to 100 kilovolts at the electrode in the spray head 154.

The spray head 154 receives air and liquid from the body 152, and uses the air to atomize and shape the liquid flowing in a downstream direction. For example, the spray head 154 receives air through the power module 168, the handle 170, and the barrel 172, while the spray head 154 receives the liquid through the power module 168 and the liquid conduit 174. Upon reaching the spray head 154, the liquid may flow along a central liquid passage, while the air may flow concentric with the liquid passage. For example, the liquid and air may exit at coaxial passages configured to atomize the liquid, while offset air passages are directed inwardly toward the atomized liquid to shape the spray. Again, the spray head 154 also may include an electrode configured to create an electrostatic field between the spray head 154 and the target object.

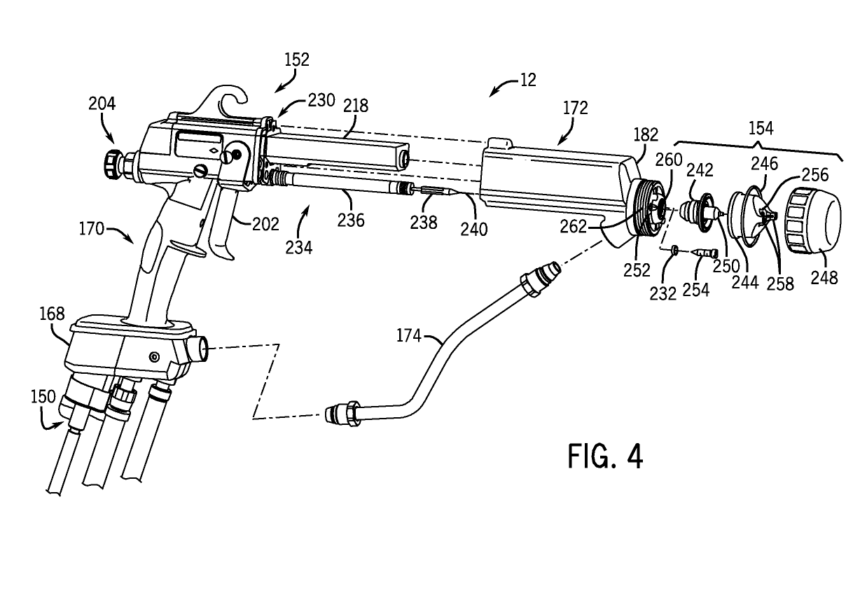

FIG. 4 is an exploded perspective view of the electrostatic spray gun 12 of FIG. 3, illustrating two unique paint blocking screens. In particular, the illustrated embodiment includes a screen gasket 230 and a screen ring 232 configured to enable air flow in a downstream direction while blocking liquid flow in an upstream direction. In the illustrated embodiment, the screen gasket 230 is disposed between the handle 170 and the barrel 172. The screen ring 232 is disposed at the front side 182 of the barrel 172 adjacent the spray head 154. As discussed further below, the screen gasket 230 and the screen ring 232 include a fine mesh screen that does not substantially restrict the air flow, but is sufficiently fine to block upstream flow of liquid into the air passages. For example, in certain embodiments, the fine mesh screen may define a grid of small openings of approximately 5 to 300 microns in width. However, the openings may vary depending on the desired resistance against upstream liquid flow and downstream air pressure drop.

As illustrated in FIG. 4, the screen gasket 230 is disposed upstream from the screen ring 232. In particular, the screen gasket 230 surrounds the cascade 218 at the interface between the handle 170 and the barrel 172. As appreciated, the barrel 172 has a hollow interior configured to receive the cascade 218 and a power valve assembly 234. In the illustrated embodiment, the power valve assembly 234 includes a shaft 236, a liquid valve 238, and an electrode 240. These elements 236, 238, and 240 are coupled together to define the assembly 234. The liquid valve 238 is axially adjustable by the liquid valve adjustor 208 and the trigger 202. For example, the trigger 202 moves the liquid valve 238 over an axial range of motion to open and close liquid flow through the spray head 154, while the liquid valve adjustor 208 may be used to vary this range of motion. In addition, the electrode 240 is configured to create an electrostatic field between the spray head 154 and the target object. When fully assembled, the cascade 218 and the shaft 236 reside within the barrel 172, while the liquid valve 238 and the electrode 240 extend into the spray head 154.

In the illustrated embodiment, the spray head 154 includes a liquid nozzle 242, an air cap 244, a seal 246, and a retaining ring 248. When assembled, the liquid valve 238 and the electrode 240 extend axially through the liquid nozzle 242, while the air cap 244, the seal 246, and the retaining ring 248 are disposed concentrically about the liquid nozzle 242. Thus, as the trigger 202 axially moves the liquid valve 238 forward and rearward through the liquid nozzle 242, the liquid valve 238 opens and closes liquid flow received from the liquid conduit 174, through the front side 182 of the barrel 172, through a central liquid passage of the liquid nozzle 242, and out through a liquid outlet 250.

At the same time, the trigger 202 controls airflow from the handle 170 through the barrel 172, and through the spray head 154. For example, the spray head 154 receives air flow through one or more air passages 252 at the front side 182 of the barrel 172. In certain embodiments, each of these air passages 252 may include a screen ring 232 configured to enable air flow in the downstream direction while substantially blocking liquid flow in the upstream direction. For example, the illustrated embodiment includes the screen ring 232 disposed in the air passage 252, while also receiving a pressure reducer screw 254 to control airflow into the spray head 154. For example, the pressure reducer screw 254 may be axially adjustable to alter the pressure drop, thereby changing the airflow through the spray head 154. In such an embodiment, the screen ring 232 may be disposed about the pressure reducer screw 254 in a sealed position between the air passage 252 and the screw 254. However, any other configuration of the screen ring 232 may be employed in the air passages 252.

As the air passes through the air passage 252, the screen ring 232, and the pressure reducer screw 254, the airflow may pass through one or more air passages in the liquid nozzle 242 prior to entering the air cap 244. Upon entering an interior of the air cap 244, the airflow may be directed through one or more air ports configured to atomize and shape the liquid exiting from the spray head 154. For example, in certain embodiments, the air cap 244 may include one or more central air ports 256 and peripheral air ports 258. For example, the central air port 256 may be disposed concentrically about the liquid port 250, such that the central air port 256 atomizes the liquid exiting the liquid port 250. The peripheral air ports 258 may be offset in a radial direction from the liquid port 250 and the central air port 256, such that the peripheral air ports 258 may shape the atomizing liquid into a desired spray shape. When assembled, the liquid nozzle 242 resides within a central liquid passage 260 of the barrel 172, the air cap 244 extends around the liquid nozzle 242, and the retaining ring 248 extends around the liquid nozzle 242, the air cap 244, and the seal 246 in a threaded connection with the barrel 172. For example, the retaining ring 248 may include threads that engage mating threads 262 at the front side 182 of the barrel 172.

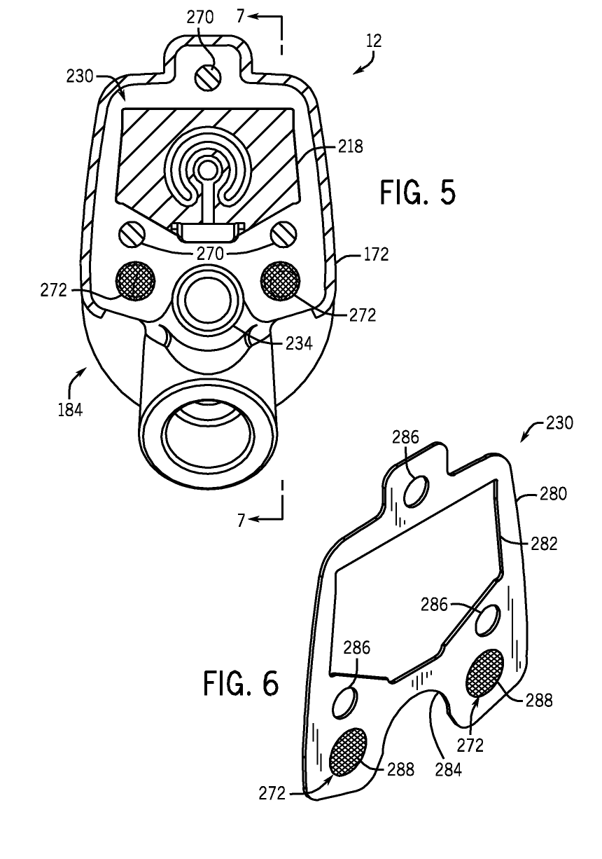

FIG. 5 is a cross-sectional view of the electrostatic spray gun 12 of FIG. 3 taken along line 5-5, illustrating unique features of the screen gasket 230 shown in FIG. 4. In the illustrated embodiment, the screen gasket 230 is disposed at the interface between the handle 170 and the barrel 172, such that the screen gasket 230 includes features to enable mechanical and fluid connections between the handle 170 and the barrel 172. In certain embodiments, the screen gasket 230 may include a self-adhesive or sealant on one or both sides, thereby enabling a quick mount and seal of the screen gasket 230. For example, the screen gasket 230 may include a removable sheet or film covering the adhesive or sealant, such that a user can remove the sheet/film at the time of assembly. However, the screen gasket 230 may exclude a self-adhesive or sealant, and simply mount between the components (e.g., handle 170 and barrel 172).

In the illustrated embodiment, the screen gasket 230 surrounds the cascade 218, the power valve assembly 234, and a set of mechanical fasteners 270. In addition, the illustrated embodiment includes liquid blocking screens 272 aligned with air passages extending from the handle 170 to the barrel 172. Thus, the liquid blocking screens 272 enable airflow while blocking liquid flow. For example, if liquid inadvertently travels upstream from the spray head 154 through the barrel 172 to the screen gasket 230, the liquid blocking screens 272 substantially block further upstream travel of the liquid into the handle 170 and the power module 168. As appreciated, it is undesirable for liquid to travel upstream through air passages due to possible liquid clogging and damage to parts otherwise designed for air rather than liquid. For example, liquid travel through air passages into the power module 168 could potentially damage the air turbine 186 and the generator 188. The inadvertent travel of liquid upstream through air passages could also damage or clog the internal air valve assemblies. Accordingly, the liquid blocking screens 272 are designed to substantially block liquid flow under typical conditions of the electrostatic spray gun 12.

FIG. 6 is a perspective view of the screen gasket 230 separate from the electrostatic spray gun 12. As illustrated, the screen gasket 230 includes a flat gasket pad 280 having the liquid blocking screens 272, a cascade receptacle 282, a valve receptacle 284, and fastener receptacles 286. Thus, the cascade receptacle 282 is configured to receive the cascade 218, the valve receptacle 284 is configured to receive the power valve assembly 234, and the fastener receptacles 286 are configured to receive the mechanical fasteners 270. In the illustrated embodiment, the screen gasket 230 includes two liquid blocking screens 272 coupled to the flat gasket pad 280. However, in alternative embodiments, the screen gasket 230 may include a single liquid blocking screen 272 or any other number of liquid blocking screens 272, e.g., 1 to 10 screens. Furthermore, the illustrated liquid blocking screens 272 have a circular geometry integrated with the flat gasket pad 280. In alternative embodiments, the liquid blocking screens 272 may have a square, rectangular, triangular, or other suitable geometry depending on the shape of air passages and other design considerations. Likewise, the liquid blocking screens 272 may be integral or separable from the flat gasket pad 280. For example, the liquid blocking screens 272 may fit removably within screen receptacles 288 in the flat gasket pad 280. In some embodiments, the screen gasket 230 may be formed in a plurality of layers, wherein an intermediate layer includes the liquid blocking screens 272. In this manner, the liquid blocking screens 272 may be completely fixed in place with the layers of the flat gasket pad 280. However, any suitable fixed or removable configuration of the liquid blocking screens 272 may be employed with the screen gasket 230 in accordance with various embodiments of the present technique.

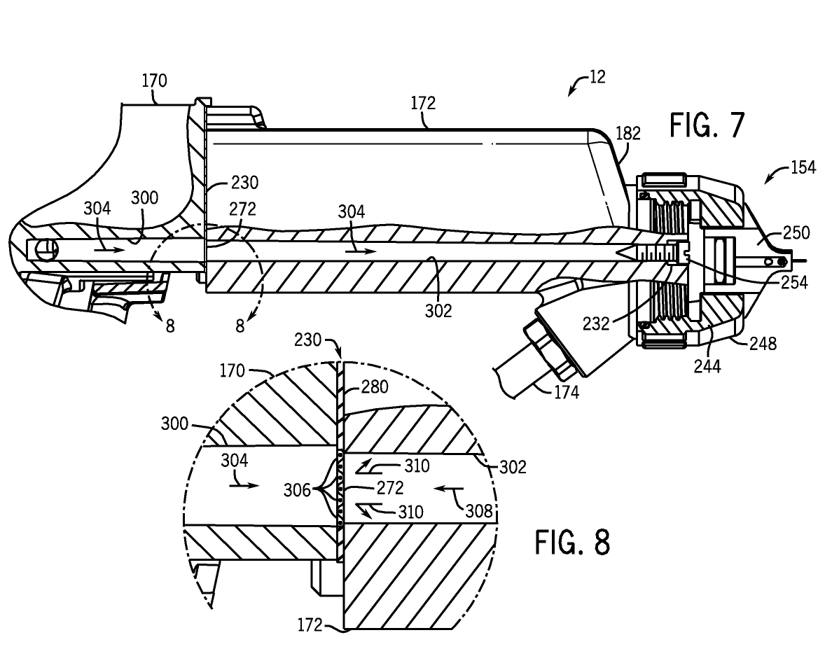

FIG. 7 is a partial cross-sectional view of the electrostatic spray gun 12 of FIG. 5 taken along line 7-7, further illustrating the screen gasket 230 and the screen ring 232 disposed along air passages 300 and 302 of the electrostatic spray gun 12. As illustrated, the screen gasket 230 is sandwiched axially between the handle 170 and the barrel 172, while the screen ring 232 is positioned axially between the pressure reducing screw 254 and the barrel 172. In particular, the screen gasket 230 is mounted in a position aligning the liquid blocking screens 272 with the air passages 300 in the handle 170 and the air passages 302 in the barrel 172. Likewise, the screen ring 232 is disposed coaxially between the pressure reducing screw 254 and the air passage 302. As air flows through the electrostatic spray gun 12, the liquid blocking screens 272 and the screen ring 232 enable free flow of air in a downstream direction 304 toward the spray head 154, while substantially blocking any liquid flow in an opposite upstream direction. In this manner, the screen gasket 230 and/or the screen ring 232 may be employed to protect upstream components (e.g., power module 168) from any ingress of liquid into the electrostatic spray gun 12.

FIG. 8 is a partial cross-sectional view of the electrostatic spray gun 12 of FIG. 7 taken within line 8-8, further illustrating the liquid blocking screen 272 at the interface between the handle 170 and the barrel 172. In particular, the liquid blocking screen 272 extends completely across the air passages 300 and 302 such that any air or liquid in these passages 300 and 302 would need to overcome any resistance in the liquid blocking screen 272.

In certain embodiments, the liquid blocking screen 272 has a grid of fine pores or openings 306 sized and spaced to provide substantially unrestricted air flow while providing substantially blocked liquid flow. For example, the openings 306 may be sized to provide a low pressure drop for airflow in the downstream direction 304 while substantially restricting liquid flow in an upstream direction 308. For example, if any liquid is able to flow upstream 308 through the air passage 302 toward the screen gasket 230, then the liquid blocking screen 272 may substantially block or repel the liquid as indicated by arrows 310. In certain embodiments, the openings 306 may have a width ranging between approximately 0 to 500 microns, 5 to 400 microns, 10 to 300 microns, or any suitable range therebetween. For example, the openings 306 may be sized at least less than 10, 20, 30, 40, or 50 microns in width. In certain embodiment, the liquid blocking screen 272 may be made with a mesh or weave of wire, fiber, or stands each having a diameter of approximately 50 to 150 microns. The liquid blocking screen 272 may be made with conductive or insulative materials. The materials may include a metal, a ceramic, a plastic, or a fiber material. For example, the weave or mesh may include a crisscross pattern of natural fibers or synthetic fibers. Exemplary synthetic fibers may include fiberglass fibers, carbon fibers, polymer fibers, or a combination thereof. However, the disclosed embodiments are not limited to any particular materials.

As appreciated, the size of the openings 306 varies the pressure drop of the airflow traveling downstream 304 while also varying the resistance to inadvertent liquid flow in the upstream direction 308. Therefore, depending on expected pressure of any liquid flowing in the upstream direction 308, the openings 206 may be sized accordingly. For example, if liquid flow is only expected under atmospheric conditions, then the openings 306 may be sized relatively larger than an expected condition with liquid under some amount of pressure. Nevertheless, the liquid blocking screen 272 provides a substantially lower pressure drop than a typical valve assembly, such as a check valve. For example, the pressure drop across the liquid blocking screen may be less than approximately 1, 2, 3, 4, or 5 percent, and the decrease in flow rate may be less than approximately 1, 2, 3, 4, or 5 percent at a given input pressure. Furthermore, the liquid blocking screen 272 is much simpler, less expensive, and more compact than valve assemblies, such as check valves.

In certain embodiments, the liquid blocking screens 272 may be employed in gaskets, seals, pressure control devices, or other suitable locations. However, the incorporation of the liquid blocking screens 272 into the flat gasket pad 280 is particularly advantageous due to its compact form and ease of assembly at the interface between adjacent components. Therefore, the screen gasket 230 may be used to add liquid blocking screens to any system having gas passages with the potential of undesirable liquid flow upstream.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a spray device gasket, comprising:
a gasket pad; and
a liquid blocking screen coupled to the gasket pad, wherein the liquid blocking screen is configured to enable gas flow in a first direction and block liquid flow in a second direction opposite from the first direction.

2. The system of claim 1, wherein the liquid blocking screen comprises a plurality of openings each having a width of less than approximately 200 microns.

3. The system of claim 1, wherein the liquid blocking screen comprises a plurality of openings each having a width of less than approximately 100 microns.

4. The system of claim 1, wherein the liquid blocking screen comprises a plurality of openings each having a width of less than approximately 50 microns.

5. The system of claim 1, wherein the liquid blocking screen is permanently fixed to the gasket pad.

6. The system of claim 1, wherein the liquid blocking screen is removably disposed in a screen receptacle in the gasket pad.

7. The system of claim 1, wherein the gasket pad comprises a cascade receptacle, a valve receptacle, or a combination thereof.

8. The system of claim 1, comprising a spray device having the spray device gasket.

9. The system of claim 8, wherein the spray device comprises an electrostatic spray device, and the liquid blocking screen is disposed along an air pathway between a power module and a spray head.

10. A system, comprising:
a spray device component; and
a liquid blocking screen coupled to the spray device component, wherein the liquid blocking screen is configured to enable gas flow in a first direction and block liquid flow in a second direction opposite from the first direction.

11. The system of claim 10, comprising a spray device having the spray device component and the liquid blocking screen.

12. The system of claim 11, wherein the spray device comprises an electrostatic spray device, and the liquid blocking screen is disposed along an air pathway between a power module and a spray head.

13. The system of claim 10, wherein the spray device component comprises a flow control component.

14. The system of claim 13, wherein the flow control component comprises a pressure reducing screw coupled to an air passage in the spray device component.

15. The system of claim 14, wherein the liquid blocking screen comprises a screen ring disposed coaxially between the pressure reducing screw and the air passage.

16. The system of claim 10, wherein the liquid blocking screen comprises a plurality of openings each having a width of less than approximately 50 microns.

17. A system, comprising:
a portable spray device, comprising:
a spray head having a liquid port and an air port;
a body comprising a barrel, a handle coupled to the barrel, a power module coupled to the handle, an air path from the power module to the spray head, and a liquid path to the spray head, wherein the power module comprises an air turbine coupled to an electrical generator; and
a liquid blocking screen disposed along the air path between the power module and the air port.

18. The system of claim 17, wherein the liquid blocking screen is coupled to a gasket.

19. The system of claim 17, wherein the liquid blocking screen is coupled to a flow control component.

20. The system of claim 17, wherein the portable spray device comprises an electrostatic spray gun having a cascade in the barrel, the cascade receives power from the electrical generator, and the cascade provides a charge to an electrode to create an electrostatic field between the spray head and a target object.
